(19) United States
(12) Patent Application Publication
(10) Pub. No.: US 2023/0126731 A1
(43) Pub. Date: Apr. 27, 2023

(54) System and method to automatically lubricate a kiln cartwheel

(71) Applicant: BID GROUP TECHNOLOGIES LTD., Prince George (CA)

(72) Inventors: Robert Gustave Peacock, Prince George (CA); Dominic Robitaille, Quebec (CA); Etienne Lacroix, Sainte-Georges (CA)

(21) Appl. No.: 18/048,687

(22) Filed: Oct. 21, 2022

Related U.S. Application Data
(60) Provisional application No. 63/262,892, filed on Oct. 22, 2021.

(51) Int. Cl. F16N 29/02; F16N 7/38

(52) U.S. Cl. CPC F16N 29/02; F16N 7/38; F27D 3/123

(57) ABSTRACT

A system for lubricating a cartwheel of a kiln cart, the system comprising a frame positioned proximate a pathway of the kiln cart, a cartwheel detector adapted to detect a position of the cartwheel and a lubricant delivery assembly affixed to said frame, said lubricant delivery assembly comprising a coupler configured to fluidly mate with a hub of the cartwheel, wherein the lubricant delivery assembly is extendable between a retracted position and an extended position, the coupler being positioned to mate with the hub of the cartwheel when the lubricant delivery assembly is in said extended position.

### CROSS-REFERENCE TO RELATED APPLICATIONS

The present patent application claims the benefits of priority of U.S. patent application No. 63/262,892, entitled “KILN AUTOMATIC GREASE SYSTEM”, and filed at the United States Patent and Trademark Office on Oct. 22, 2021, the content of which is incorporated herein by reference.

### FIELD OF THE INVENTION

The present invention generally relates to apparatuses and methods for automatically greasing kiln carts.

### BACKGROUND OF THE INVENTION

Wood dry kilns are well-known in the wood industries. Conventional wood dry kilns typically comprise rails on which carts carry wood charges inside a hot chamber. To maintain carts in a good state of operation, the cartwheels must be regularly greased. Typically, an operator greases the kiln cartwheels after each passage through a kiln, such as a continuous dry kiln. The greasing process is time consuming and involves risks for the operator, especially when performed in icy conditions.

Some grease systems are mobile and could be moved close to the cartwheels. However, such mobile grease systems are sensitive to high temperatures and therefore cannot be used in a continuous dry kiln where temperature can reach over 240° F.

Some other prior art kiln carts comprise plastic bushings. The plastic bushings require less grease but are typically still greased to improve their lifespan.

There is therefore a need for an improved system and method to grease kiln cartwheels with minimum or no human intervention.

### SUMMARY OF THE INVENTION

The shortcomings of the prior art are generally mitigated by a system for automatically lubricating a cartwheel of a kiln cart. The system comprises a frame proximate to a pathway of the kiln cart, a cartwheel presence detector and a lubricant delivery assembly comprising a cartwheel hub coupler, the coupler being movable in relation to the frame to fluidly mate with the hub of the cartwheel upon detection of the presence of the cartwheel by the detector.

The system may further comprise a controller, the controller being in signal communication with the cartwheel presence detector and the lubricant delivery system. The lubricant delivery assembly may further comprise a coupler position sensor to detect position of the coupler in relation to the hub. The system may further comprise a pump configured to pressurize the lubricant to deliver to the hub upon detection of an engagement position of the coupler to the hub.

The system may further comprise a lubricant line comprising a first end in fluid communication with a lubricant supply source and a second end in fluid communication with the lubricant delivery assembly. The lubricant delivery assembly may further comprise a resilient member pushing against the hub of the cartwheel when the delivery assembly is engaged with the hub.

The coupler may comprise a nozzle. The cartwheel detector may comprise at least one of a photocell and a laser.

The system may comprise a positioning system configured to move the lubricant delivery system between a retracted position and an engaged position. The positioning system may comprise an actuator.

The system may further comprise a controller in signal communication with the cartwheel presence detector, the pump and the coupler position sensor.

The lubricant delivery assembly may be pivotable along a vertical axis. The system may further comprise a detector assembly adapted to detect pivoting movement of the lubricant delivery assembly.

In another aspect of the invention, a method of lubricating a cartwheel of a kiln cart is provided. The method comprises detecting presence of a cartwheel within a predetermined distance, automatically moving a coupler to mate with a hub of the detected cartwheel and delivering a lubricant to the hub of the cartwheel through the mated coupler.

The method may further comprise detecting the mating of the coupler with the hub of the cartwheel. The method may further comprise pressurizing the lubricant when the mating of the coupler to the hub of the cartwheel is detected.

The method may comprise moving the coupler away of the hub of the cartwheel once a predetermined volume of lubricant has been delivered to the cartwheel or the hub of the cartwheel.

The method may further comprise impelling the coupler towards the hub of the cartwheel when the coupler is mating with the hub. The moving the coupler may further comprise activating an actuator. The method may further comprise pivoting the coupler along a vertical axis to avoid breakage of the said coupler.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of an automatic lubrification system illustrated with a kiln cart before greasing a kiln cartwheel in accordance with the principles of the present invention.

FIG. 2 is a perspective view of the automatic lubrification system of FIG. 1 illustrated in the process of greasing a kiln cartwheel.

FIG. 3 is a top plan view of the automatic lubrification system of FIG. 1.

FIG. 4 is an enlarged top plan view of the automatic lubrification system of FIG. 1.

FIG. 5 is a top plan view of the coupler assembly of FIG. 4 shown prior to lubricating a kiln cartwheel.

FIG. 6 is a top plan view of the couple assembly of FIG. 4 in position to lubricate a kiln cartwheel.

FIG. 7 is a sectional view of an automatic lubrification system illustrated with a kiln cart during greasing of a kiln cartwheel in accordance with the principles of the present invention.

FIG. 8 is perspective partial view of an automatic lubrification system in accordance with the principles of the present invention, shown with the coupler assembly being straight.

FIG. 9 is perspective partial view of the automatic lubrification system of FIG. 7 shown with the coupler assembly being pivoted.

### DETAILED DESCRIPTION OF THE INVENTION

A novel system and method to automatically lubricate a kiln cartwheel will be described hereinafter. Although the invention is described in terms of specific illustrative embodiments, it is to be understood that the embodiments described herein are by way of example only and that the scope of the invention is not intended to be limited thereby.

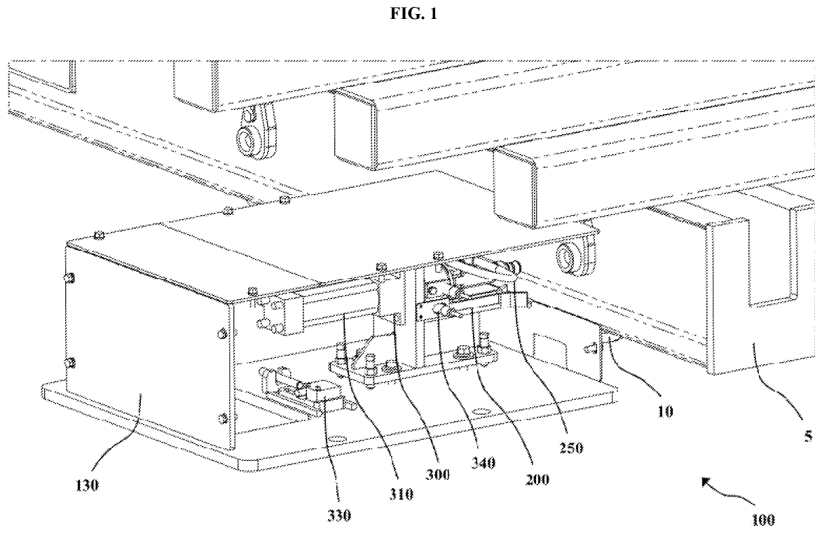

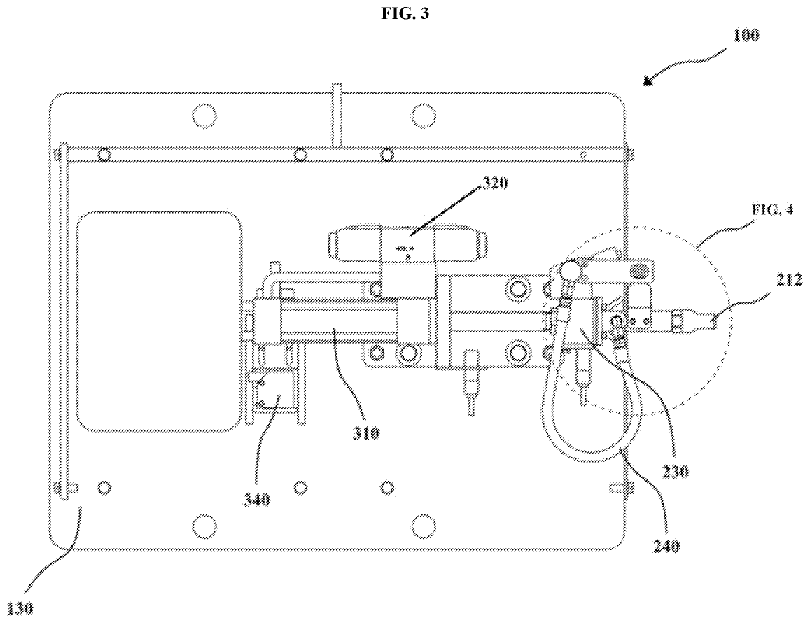

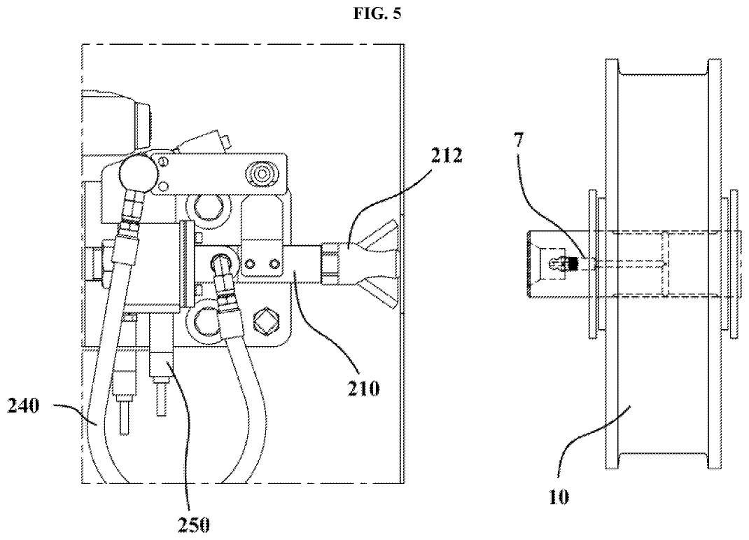

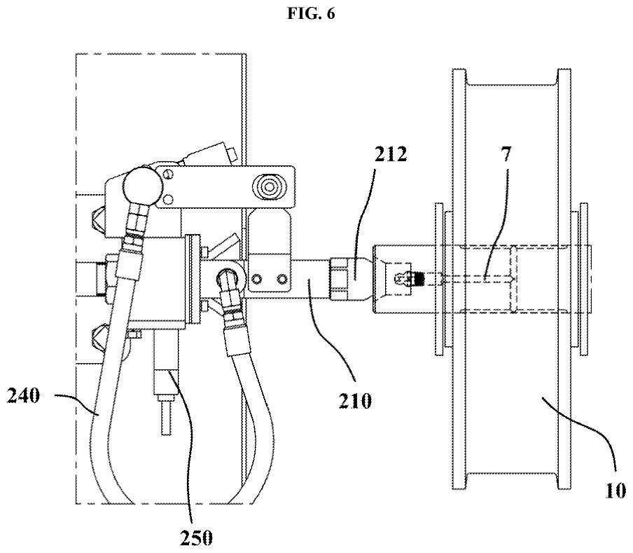

Referring to FIGS. 1 to 6, an embodiment of an automatic lubrification system 100 for greasing a cartwheel 10 of a kiln cart 5 is illustrated. The greasing system 100 may be installed beside or near a kiln cart pathway or rail. The greasing system 100 is typically positioned within reach of the cartwheel 10 to effectively lubricate it. In certain embodiments, the lubrification system 100 may be at least partially enclosed within a frame 130 to protect said lubrification system 100 from snow, rain, wood board, debris or any other potentially damaging element. The frame may be affixed to the floor, a wall or any other suitable structure of the kiln and may be made of metal, plastic or any other suitable material.

Broadly the lubrification system 100 comprises a delivery assembly or coupler assembly 200 adapted to deliver a lubricant to the cartwheel 10, and a positioning system 300 adapted to position the coupler assembly 200 toward the cartwheel 10 when the said cartwheel 10 is located near the lubrification system 100.

The positioning system 300 allows the coupler assembly 200 to move towards and away from the passing cartwheel 10. The positioning system 300 generally comprises an actuator 310. In certain embodiments, the actuator 310 may be electric, hydraulic or pneumatic. In embodiments wherein the actuator 310 is hydraulic or pneumatic, the positioning system 300 further comprises a hydraulic or pneumatic valve 320 adapted to selectively control the delivery of a hydraulic or pneumatic fluid. In such embodiments, the valve 320 may be mounted directly on or adjacent to the actuator 310. Understandably, the valve 320 may be positioned in any other suitable position.

In some embodiments, the hydraulic valve 320 allows the control of the movement of a cylinder 312 of the actuator 310. The cylinder 312 moves the coupler assembly 200 toward and away from the passing cartwheel 10.

In certain embodiments, the positioning system 300 further comprises a position sensor 340 adapted to detect a position of the actuator 310 when moved. The position sensor 340 may comprise a proximity switch, a photosensor, a potentiometric position sensor, an encoder or any other suitable system for detecting an object's position. The position sensor 340 may be used to determine if the actuator 310 is in an extended or collapsed position. Alternatively, the proximity sensor 340 or another sensor may be configured to determine a position of the coupler assembly 200.

The positioning system 300 may further comprise a cartwheel detector 330. The cartwheel detector 330 is preferably positioned within a retracted location in the frame 130 such as to be protected from snow, rain, wood board, debris or any other element which may damage said cartwheel detector 330. The cartwheel detector 330 may comprise a photocell, a laser or any other suitable system for detecting the presence of a kiln cartwheel 5.

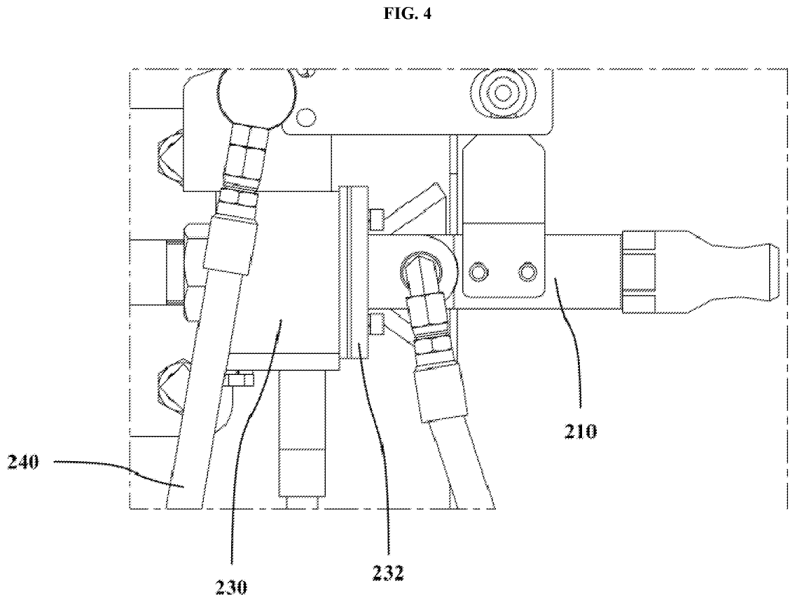

Now referring to FIGS. 4 to 6, the coupler assembly 200 generally comprises an elongated portion 210 defining a nozzle 212 configured to mate with a cartwheel hub 7 to deliver the lubricant thereto. To deliver the lubricant, the nozzle 212 is positioned to be placed in fluid communication with a cartwheel hub channel 7.

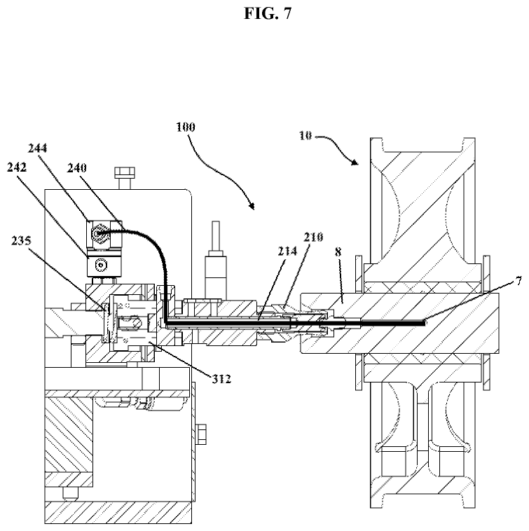

Referring now to FIGS. 4 and 7, in certain embodiments, the coupler assembly 200 may further comprise a resilient member 235 enclosed within a piston frame 230 enclosing and a piston cover 232. The resilient member 235 may comprise a spring or any other suitable mechanism for storing and releasing mechanical energy. The resilient member 235 is compressed when the elongated portion 210 is pushed in the cartwheel hub 7. The resilient member 235 thus generally maintains pressure of the coupler assembly 200 against cartwheel hub 7 to limit or block leaks of lubricant during the delivery. The resilient member 235 may further be used to adjust the length of the coupler assembly 200 to adapt to different sizes of wheels 10. The resilient member 235 may further allows a slight vertical movement of the coupler assembly 200 to adjust the different sizes or heights of the cartwheel 10. Indeed, each cartwheel 10 may have slight differences in sizes and shape from one another.

When the actuator 310 is retracted, the resilient member 235 pulls the coupler assembly 200 away from the cartwheel hub 7 to disengage the said coupler assembly 200.

The coupler assembly 200 may further comprise a lubricant line 240 with a first end in fluid communication with the elongated portion 210 adapted to supply lubricant to said elongated portion 210. The lubricant line 240 may comprise a second end fluidly connected to a lubricant supply source (not shown). In certain embodiments, the lubricant supply source may comprise a pump 242 to pressurize the lubricant supplied within said lubricant line 240.

Referring now to FIG. 7, the elongated portion 210 further comprises a conduit 214 in fluid communication with the lubricant line 240 and adapted to channel the lubricant to the nozzle 212.

The coupler assembly 200 may similarly comprise a position sensor 250 adapted to detect a position of the elongated portion 210. The position sensor 250 may comprise a proximity switch, a photosensor, a potentiometric position sensor, an encoder or any other suitable system for detecting an object's position. In operation, the controller may be configured to allow delivery from the lubricant supply source when the position sensor 250 detects a predetermined position of the elongated portion 210 representative of an engagement with the cartwheel hub 7. The controller may be configured to activate a pump 242 or to open a valve 244 from the lubricant supply source to the nozzle 212.

In embodiments where the position sensor 250 is embodied as a proximity switch, the proximity switch is configured to communicate a signal when the nozzle 212 is not pushed in the cartwheel hub 7. The proximity switch is further configured to stop sending a signal when the nozzle 212 is inserted in the cartwheel hub 7. As such, when no signal is received from the proximity switch, the pump 242 is activated to pressurize the lubricant or grease in the lubricant line 240. Understandably, any other type of position sensor 250 may be used to sent or stop sending a signal in order to activate or deactivate the pump 242.

The nozzle 212 may be shaped to align between the elongated portion 210 and the cartwheel hub 7. The interlocking bushing 8 is made in plastic but can be made in any other suitable materiel.

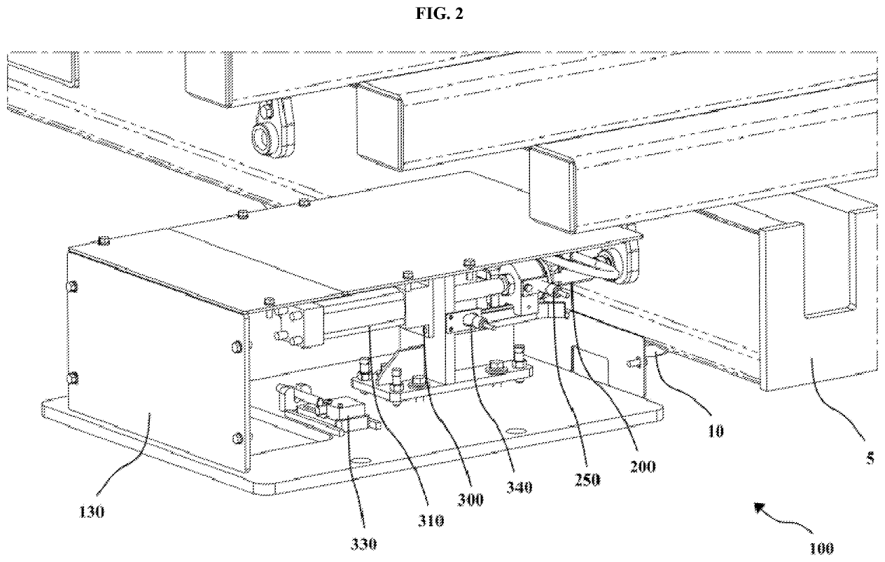

FIG. 2 illustrates the automatic lubrification system 100 positioned as the kiln cart 5 approaches said system 100. As the kiln cart 5 approaches, the cartwheel detector 330 detects presence of a cartwheel 10 near the lubrication system 100 or aligned with the lubrication system 100. As described above, in some embodiments, the cartwheel detector 330 may be a laser system. In some embodiments, the cartwheel detector 330 sends a signal to the controller of the system 100 confirming detection of said cartwheel 10. Upon receiving the signal, the system 100, or in some embodiments the controller of said system 100, activates the positioning system 200, such as a hydraulic actuator. While the positioning system 300 moves the coupler assembly 200 toward the cartwheel 10, the position sensor 340 may send the position of the coupler assembly 200 to the controller. When the coupler assembly 200 is positioned adjacent or is in contact with the cartwheel hub 7, the coupler assembly 200 may be locked in position with the cartwheel hub 7. In some embodiments, the cartwheel hub 7 comprises a bushing adapted to lock the nozzle 212 inside the hub 7. As the coupler assembly 200 (or nozzle 212) is positioned, the resilient member 235 is pressed against the cartwheel 10 for delivery of the lubricant in the cartwheel hub 7. In some embodiments, when the resilient member 235, and in some embodiments the spring, is compressed, a piston is loosened to activate the flow of lubricant to the hub 7.

In other embodiments, a proximity sensor 250 detects that the nozzle 212 is locked in the hub 7 and send a signal to the system 100 (or a controller of the system 100). Upon receiving the signal, the system 100 activates the pump to pressurize the lubricant. The pressurized lubricant then moves in the hub.

After the greasing is completed, the coupler assembly 200 may be unlocked from the hub 7, such as by the actuator pulling on the elongated member away from the hub 7.

Now referring to FIGS. 4 to 6, an enlarged view of an embodiment of the coupler assembly 200 and of a kiln cartwheel 10 is illustrated. The nozzle 212 is moved toward the cartwheel 10 and is connected to the grease fitting of the cartwheel 10. When the nozzle 212 is fitted in the grease fitting, the system 100 may activate a lubricant grease pump 242 to pressurize the lubricant present in the lubrication line connected from the lubricant source to the nozzle 212. Upon pressurization, the lubricant starts flowing through the lubrication line in the cartwheel hub 7 or on the bushing. After delivering a volume of lubricant to the cartwheel 10, the coupler assembly 200 is retracted to its initial position. Understandably, the volume of lubricant to be delivered to the cartwheel 10 may be predetermined such as using a debit detector or by letting the pressurize lubricant to flow during a predetermined period of time being equivalent to the required volume of lubricant for the cartwheel 10. During the positioning process, the position sensor 340 detects and transmits to the controller the position of the coupler assembly 200 relative to the cart rail or pathway. The detected position of the coupler assembly 200 may be used to trigger the start of the delivery of lubricant to the cartwheel 10. The delivery may be triggered by activating the pump to pressurized the lubricant in the inner conduit 214 of the coupler assembly 100.

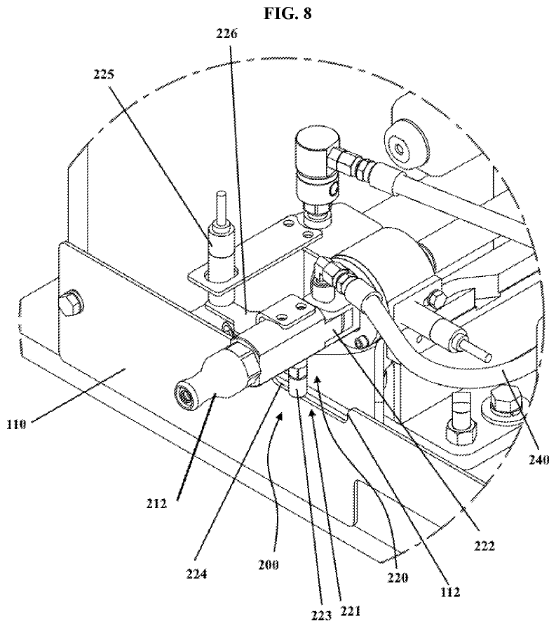

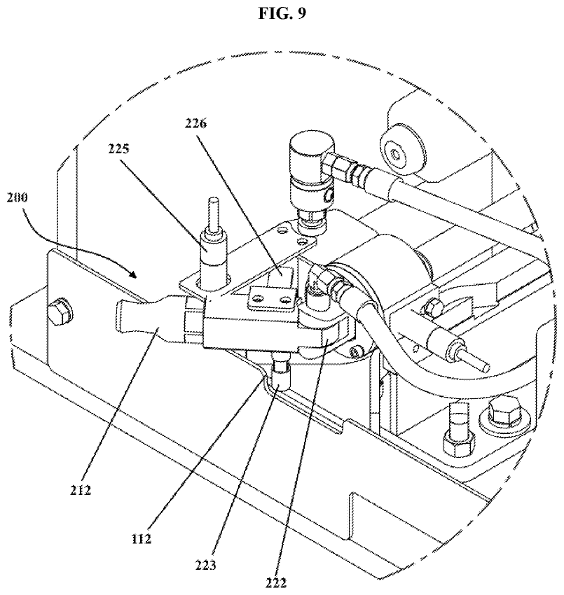

Referring now to FIGS. 8 and 9, an embodiment of an automatic lubrification system 100 having a pivotable coupler assembly 200 is illustrated. The pivotable coupler assembly 200 generally aims at avoiding breakage of the coupler assembly 200 or any other part of the automatic lubrication system 100 when the cartwheel 10 slightly move during greasing or while the coupler assembly 200 is still engaged in the cartwheel hub 7. In such embodiment, the system comprises a pivoting system 220 generally comprises a pivot point 222 at one end of the elongated member 210 or nozzle 212 and a guiding system 223, 224.

The guiding system 221 generally comprises a guiding member 223 and a guiding track 224 slidingly mating with the guiding member 223. The guiding member 223 is typically embodied as a rod downwardly extending from the elongated member 210. The guiding track 224 is typically located on a body or frame of the automatic lubrication system 100. As illustrated, the guiding track 224 is a groove in an external panel 110 of the automatic lubrication system 100. The groove 110 comprise stoppers 112 for limiting the pivoting movement of the elongated member 210. As such, the guiding member 223 abuts against each of the stoppers 112 when the elongated member 212 pivots.

The pivot point 222 generally comprises a conduit (not shown) in fluid communication with the lubricant line 240 and the inner conduit 214 of the elongated member 210. As such, the lubricant fluid may circulate to the nozzle 212 even if the coupler assembly 200 is pivoted.

The pivoting system 220 may further comprise a sensing element adapted to detect pivoting of the coupler assembly 200. In the illustrated embodiment, the sensing element comprises a limit switch 225 and a detectable member 226 attached to the coupler assembly 200. When the coupler assembly 200 moves, the detectable member 226 moves away from the limit switch 225 which then notify the system 100 that the coupler assembly 200 has pivoted. Understandably, the limit switch 225 may be replaced with any other known detector or sensor, such as but not limited to a proximity switch, a laser-based sensor, etc. The sensing element is configured to send a signal to the system 100 meaning presence or absence of the detectable member 226.

The pivoting system 220 may further comprise a roll-back mechanism adapted to reposition the pivoted coupler assembly 200 to a non-pivoted position. The roll-back mechanism may comprise a resilient member or an actuator for moving the coupler assembly 200 back to a working position.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A system for automatically lubricating a cartwheel of a kiln cart, the system comprising:
a frame proximate to a pathway of the kiln cart;
a cartwheel presence detector; and
a lubricant delivery assembly comprising a cartwheel hub coupler, the coupler being movable in relation to the frame to fluidly mate with the hub of the cartwheel upon detection of the presence of the cartwheel by the detector.

2. The system of claim 1 further comprising a controller, the controller being in signal communication with the cartwheel presence detector and the lubricant delivery system.

3. The system of claim 2, the controller being in further signal communication with the pump and the coupler position sensor.

4. The system of claim 1, wherein the lubricant delivery assembly further comprises a coupler position sensor to detect position of the coupler in relation to the hub.

5. The system of claim 4 further comprising a pump configured to pressurize the lubricant to deliver to the hub upon detection of an engagement position of the coupler to the hub.

6. The system of claim 1 further comprising a lubricant line, the lubricant line comprising a first end in fluid communication with a lubricant supply source and a second end in fluid communication with the lubricant delivery assembly.

7. The system of claim 1, wherein the coupler comprises a nozzle.

8. The system of claim 1, wherein the lubricant delivery assembly further comprises a resilient member pushing against the hub of the cartwheel when the delivery assembly is engaged with the hub.

9. The system of claim 1, wherein the cartwheel detector comprises at least one of a photocell and a laser.

10. The system of claim 1 further comprising a positioning system configured to move the lubricant delivery system between a retracted position and an engaged position.

11. The system of claim 10, wherein the positioning system comprises an actuator.

12. The system of claim 1, the lubricant delivery assembly being pivotable along a vertical axis.

13. The system of claim 12 further comprising a detector assembly adapted to detect pivoting movement of the lubricant delivery assembly.

14. A method of lubricating a cartwheel of a kiln cart, the method comprising:
detecting presence of a cartwheel within a predetermined distance;
automatically moving a coupler to mate with a hub of the detected cartwheel; and
delivering a lubricant to the hub of the cartwheel through the mated coupler.

15. The method of claim 14 further comprising detecting the mating of the coupler with the hub of the cartwheel.

16. The method of claim 15 further comprising pressurizing the lubricant when the mating of the coupler to the hub of the cartwheel is detected.

17. The method of claim 14 further comprising moving the coupler away of the hub of the cartwheel once a predetermined volume of lubricant has been delivered to the cartwheel.

18. The method of 14 further comprising impelling the coupler towards the hub of the cartwheel when the coupler is mating with the hub.

19. The method of claim 14, wherein moving the coupler further comprises activating an actuator.

20. The method of claim 14 further comprising pivoting the coupler along a vertical axis to avoid breakage of the said coupler.
